(19) United States
(12) Patent Application Publication
(10) Pub. No.: US 2021/0031354 A1
(43) Pub. Date: Feb. 4, 2021

(54) Multi-Purpose Ratchet Wrench Extension

(71) Applicant: Scott Francis Harr, Latrobe, PA (US)

(72) Inventor: Scott Francis Harr, Latrobe, PA (US)

(21) Appl. No.: 16/529,712

(22) Filed: Aug. 1, 2019

(51) Int. Cl. B25G 1/04; B25B 13/46; B25B 13/48; B25B 23/16

(52) U.S. Cl. CPC B25G 1/043; B25B 13/462; B25B 23/0035; B25B 23/16; B25B 13/481

(57) ABSTRACT

A ratchet wrench set including a ratchet wrench, an extension and sockets. The extension is employed both as a driver extension and a handle extension. The extension is used by a workman to assist in accessing a hard to reach fastener simply by manually coupling the extension to the ratchet wrench driver member at one end and to a socket to the other end of the extension. Alternatively, a workman can couple the extension to the ratchet wrench handle to extend its longitudinal length and thereby improve torque leverage. The extension may have a shaft that is adapted to improve a workman's handgrip so that whenever the extension is longitudinally coupled onto the handle portion of the ratchet wrench it may be more readily gripped.

### FIELD OF THE INVENTION

The present invention relates to ratchet wrench sets. The present invention ratchet wrench set includes an extension that may be used by a workman as either a handle extension or as a drive extension.

### BACKGROUND OF THE INVENTION

The general use of and construction of ratchet wrench sets is well known in the prior art. Ratchet wrench sets heretofore devised and utilized are known to consist basically of familiar, expected and obvious structural configurations. A ratchet wrench is a hand tool having a metal handle attached to a ratcheting mechanism which attaches to a socket. The socket is shaped to fit onto a type of bolt or nut, an appropriately sized socket is selected by a workman and snapped onto the ratchet wrench driver. Once assembled the socket is positioned so that the it is snugly placed on the nut or bolt, next the handle may be manually rotated by the workman in one direction to loosen or tighten the bolt or nut. Rotated in the other direction, the ratchet wrench does not rotate the socket but allows the ratchet handle to be re-positioned for another rotation while staying attached to the bolt or nut. A switch is built into the ratchet wrench that allows the user to apply the ratcheting action in either rotational direction, as needed, to tighten or loosen a fastener.

The ratchet wrenches included in ratchet wrench sets have a relatively short longitudinal length, typically ranging from six (6) inches to eight (8) inches. It has often been proposed in the past to increase the torque of a ratchet wrench, by providing an extensible torque rods in which the handle moves longitudinally on the shank for increased length. Once the handle is extended outwardly so the outer end can be turned by a handle at right angles to the rod in the manner of a crank. The longer handle increases the workman's leverage as in: U.S. Pat. No. 4,070,932 (Jeannotte). U.S. Patent Publication No. 2014/0290449 (Hsieh) and U.S. Patent Publication No. 2007/0044597 (Pryor). These extensible handle devices can be used to reach and loosen or tighten fasteners in difficult places where a wrench or relatively shorter ratchet wrench could not be turned.

It has also been proposed in the prior art to increase the length of a first ratchet wrench by coupling another second ratchet wrench to the end opposite the driving end of a first ratchet wrench placed on a fastener. The first and second ratchet wrenches have non-extendable straight shanks. The ratchet wrenches are made with coupling means so that they can be mounted end to end in a straight line to multiply the leverage of a single ratchet wrench. See U.S. Pat. No. 4,596,167 (White. Jr.) and U.S. Patent Publication No. 2007/0051212 (Hsieh).

Extra handle attachments have been employed in the prior art to increase the overall length of the handle. These ratchet wrench sets are disclosed in U.S. Pat. No. 2,282,148 (Mandl) and U.S. Pat. No. 6,378,400 (Bogli). The added length to the primary ratchet wrench handle improves the torque leverage of the ratchet wrench.

While these devices fulfill their respective, particular objectives and requirements, the aforementioned patents do not disclose a more compact and expedient ratchet set having one less piece.

### SUMMARY OF THE INVENTION

The present ratchet set invention includes at least a ratchet wrench having a head portion and at its opposite end a handle portion, a plurality of sockets and an extension. The inventive feature of the ratchet set is that an extension in the set may be employed by a workman as either a handle extension to improve torque leverage or as a drive extension.

In a first ratchet set embodiment the extension has a female portion and male portion. A drive member of the ratchet head portion is adapted to be received and coupled within the female portion of the extension. The male portion of the extension is adapted to be received and coupled within a first end the socket. Said extension may alternatively be employed by a workman to increase the torque leverage of the ratchet wrench. In this instance the male portion of the extension is insertable into a complimentary receptacle located at the end of the ratchet wrench handle. Upon inserting and coupling the extension male portion within the receptacle at the end of the ratchet wrench handle portion a user may now grasp the extension to rotate a ratchet wrench socket for either tightening or loosening a fastener.

In a second ratchet set embodiment the extension has a female portion and male portion. A drive member of the ratchet head portion is adapted to be received and coupled with the female portion of the extension. The male portion of the extension is adapted to be received and coupled within a first end of the socket. Said extension may alternatively be employed by a workman to increase the torque leverage of the ratchet wrench. In this instance the female portion of the extension is coupled with a complimentary male member section located at the distal end of the ratchet wrench handle. Upon inserting the ratchet wrench handle male member within the extension female portion a user may now grasp the extension to rotate a ratchet wrench socket for either tightening or loosening a fastener.

In these respects, the ratchet wrench set according of the present invention substantially departs from the conventional concepts and designs of the prior art, and in so doing slightly modifies the handle portion of a ratchet wrench so as to incorporate a “driver” extension alternatively as a means for extending the longitudinal length of the wrench and thereby improving torque leverage. In other preferred embodiments said extension may have a shaft that is adapted to improve a workman's handgrip so that whenever the extension is longitudinally added onto the handle portion of the ratchet wrench it may be more readily gripped.

These together with other objects of the invention, along with the various features of novelty which characterize the invention, am pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and summary objects other than those set forth above will become apparent when consideration is given to the following detailed description and drawings:

FIG. 1 is a perspective view of a ratchet wrench according to a first embodiment of the present ratchet wrench set invention.

FIGS. 2A, 2B & 2C are perspective views of typical well-known sockets that may be employed with the present ratchet wrench set invention.

FIG. 3 is a perspective view of an extension according to the present ratchet wrench set inventions.

FIG. 4 is a perspective view of the present invention extension shown in FIG. 3 coupled onto the ratchet wrench of the second embodiment of the invention shown in FIG. 1.

FIG. 5 is a perspective view of a ratchet wrench according to a second embodiment of the present ratchet wrench set invention.

FIG. 6 is a perspective view of the present invention extension shown in FIG. 3 coupled onto the ratchet wrench of the second embodiment of the invention shown in FIG. 5.

### DETAILED DESCRIPTION

A more complete understanding of the present invention can be had by referring to the following detailed description together with the accompanying drawings. Referring now to the drawings, wherein like reference numerals designate like or corresponding parts throughout several views. FIG. 1 illustrates a ratchet wrench for a first embodiment of the invention.

In accordance with the first embodiment of the present invention, a ratchet wrench 10 is provided for rotating a fastener. The ratchet wrench 10 includes a handle at one end thereof and a head 16 at the other end. The head 16 and handle 12 are connected together by a shaft 14. The ratchet head having a central longitudinal axis. The head 16 includes a ratcheting mechanism portion 18 and drive member 20 centered along a central longitudinal axis (see FIG. 1). The drive member 20 is shaped and configured for attachment to sockets. The handle 12 and shaft 14 are integral and have one continuous central longitudinal axis (see FIG. 1). The handle/shaft longitudinal axis is perpendicular to the ratchet head axis. At the very distal end 13 of the cylindrical handle is an opening into a square mounting receptacle 15.

The head includes a switch 22 for selecting the ratchet wrenches rotational direction. The switch is on the opposite side of the ratchet head to the drive member 20. For instance, the switch is used for changing the socket wrench between loosening or tightening. The switch 22 may be turned clockwise into one position for tightening and counterclockwise into a second position for loosening. A workman can easily reverse the effective rotational direction of the ratchet wrench 10 simply by grasping the reverser switch 22 and moving it to the other position even as the socket still remains on the fastener.

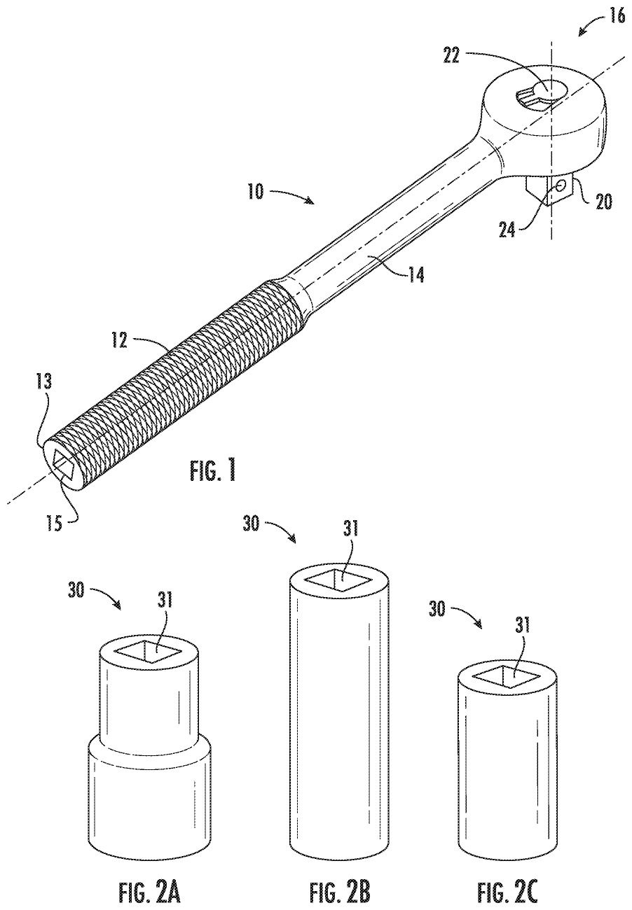

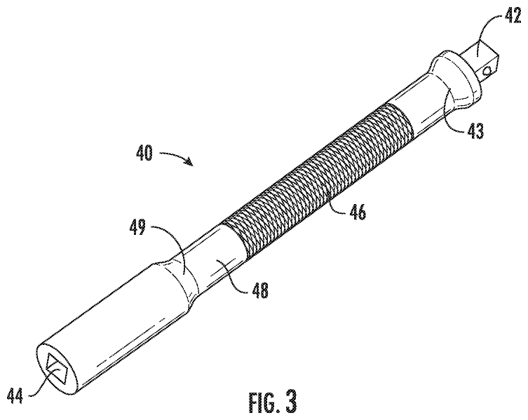

The drive member 20 is permanently fixed to the handle 12, the drive member 20 has a well-known spring-loaded detent ball 24 for assisting in securing a socket to the drive member 20. FIGS. 2A, 2B and 2C are representative of a few of the types of prior art sockets in industry and disclose a variety of well-known sockets commonly found amongst a workman's socket wrench set. FIG. 2A illustrates a socket for use with a relatively large fastener, FIG. 2C illustrates a socket used for a relatively small fastener and FIG. 2B illustrates a deep-dish socket. The present invention ratchet wrench set may have a large variety of sockets having different sizes and shapes for attachment to fasteners commonly found in the industry (e.g. on vehicles) numbering between ten (10) to forty (40) sockets. Typical domestic handyman's ratchet wrench starter sets, for instance found on hardware store shelfs, have a variety of both imperial and metric sized sockets and may include from twelve (12) to twenty-four (24) different sockets. The design of these sockets included with domestic handyman ratchet wrench sets will be typically employed for small bolts and nuts and larger bolts or nuts. Commercial mechanics may have much larger socket wrench sets that can include over one hundred (100) different types of sockets. It is contemplated that in another preferred embodiment of the present invention ratchet wrench socket set, the set may include between forty-one (41) to one hundred (100) sockets. It is contemplated that in yet another preferred embodiment of the present invention ratchet wrench socket set, the set may include at least one hundred (100) sockets.

The drive member in FIG. 1 has a square cross-section. The sockets 30 each have a square female coupler hole 31 configured to cooperate with the drive member 20 for assisting in securely coupling a socket 30 to the ratchet wrench 10. Once coupled to the drive member 20 the central axis of the attached socket is perpendicular to the longitudinal axis of the wrench 10. The ratchet wrench 10 once coupled with a socket 30 may be used to rotate the socket 30 about its central axis. The socket 30 is manually coupled by the workman onto the ratchet drive member 20 by pushing the socket onto the drive member and conversely can be easily removed by manually pulling the socket 30 of the drive member 20.

In operation a socket 30 is selected by a workman so as to fit a fastener desired to be tightened or loosened. The socket is then attached to the wrench drive member 20 and the second end of the socket is placed on the fastener. The drive member 20 is now operably connected to the fastener so that rotation of the ratchet wrench in the switched-in direction also rotates the fastener. The workman then may grasp the ratchet wrench handle 12 and rotate the ratchet wrench either to loosen or tighten the fastener. The fastener may include but is not limited to bolts, nuts or other well-known fasteners. Multiple types of screw heads on screw are well-known and used throughout industry as well along with corresponding ratchet wrench sets having male driver sockets for loosening and tightening these screws such as but not limited to Phillips Head male driver sockets.

The drive member 20 may also be coupled to extension 40 which is then coupled to a selected socket 30. The extension 40 has a square male connector 42, at least nearly identical in configuration and size to the drive member 20, for engagement with the square female coupler hole 31 of each of the sockets 30. The square male connector 42 has a spring-loaded detent ball (unnumbered). The opposite end of the extension 40 has a square female receptacle 44 for coupling the drive member 20 to the extension. When an extension 40 is needed by an operator to assist in accessing a hard to reach fastener the extension 40 can be inserted between the ratchet wrench 10 and a socket 30 and quickly assembled together manually. Likewise, extension 40 can be quickly removed manually from the ratchet wrench assembly when it is no longer needed.

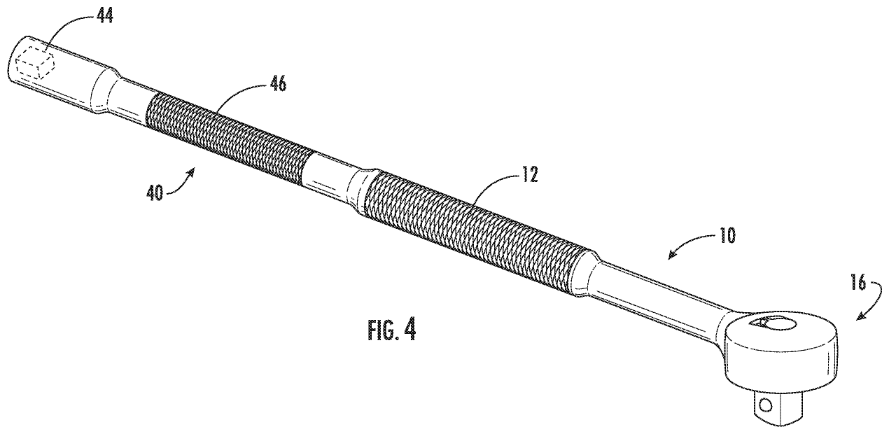

In the first embodiment of the present invention the extension piece 40 may alternatively be used to increase the torque leverage of the ratchet wrench. The extension 40 is coupled to the ratchet wrench 10 by first aligning the central axis of the extension with the longitudinal axis of the wrench; then rotating the extension so that the square male connector is oriented to coincide with the position of the square receptacle 15 located at the end of the ratchet wrench 10 handle; and then finally fully inserting the male connector 42 into the female receptacle 15. FIG. 4 illustrates the first embodiment of the invention wherein the extension 40 is attached to the end of ratchet wrench 10. As discussed above a selected socket is coupled to the drive member of the ratchet wrench in FIG. 4. To complete the assembly.

Upon inserting and coupling the extension 40 within the receptacle 15 at the end of the ratchet wrench handle a user may now grasp the extension 40 assembled onto the very end of the ratchet wrench to rotate a ratchet wrench socket and tighten or loosen a fastener. The extension 40 has a knurled handgrip section at 46. The handgrip is generally cylindrical and has knurls thereon for improving the grasp. As seen in FIG. 4 the diameter of the handgrip 46 is slightly less than the diameter of the handle 12 on the ratchet wrench and the extension handgrip 46 may have a longitudinal length approximately the same length as the handle 12. Alternatively, the handgrip section 46 may have the same diameter as the handle 12 on the ratchet wrench. Whenever the ratchet wrench set is assembled together as shown in FIG. 4 greater torque can be more easily applied by a workman to tighten or loosen a fastener on account of the greater leverage achieved by the wrench's added length.

The extension 40 in a preferred embodiment has a length of between 2 inches to 24 inches, in another preferred embodiment has a length of between 4 inches to 22 inches, in another preferred embodiment has a length of between 6 inches to 22 inches, in another preferred embodiment has a length of between 8 inches to 18 inches, in another preferred embodiment has a length of between 10 inches to 16 inches, in another preferred embodiment has a length of between 12 inches to 14 inches and in another preferred embodiment has a length of between 18 inches to 22 inches.

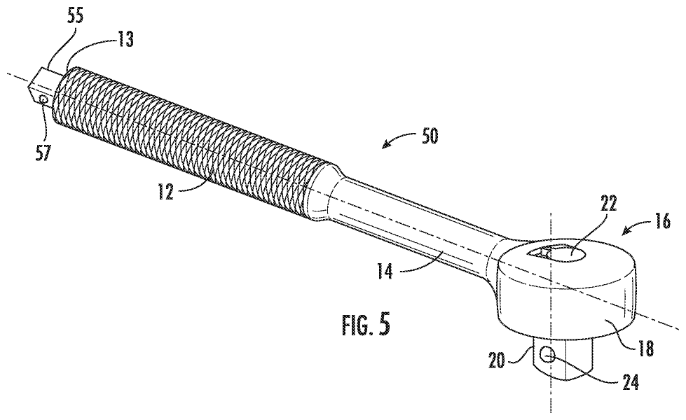

FIG. 5 illustrates a ratchet wrench 50 of a second embodiment of the present invention. This ratchet wrench 50 like the ratchet wrench 10 shown in FIG. 1 is part of a socket wrench set including at least multiple sockets 30 (FIGS. 2A, 2B, 2C) and an extension 40. Similar to the first embodiment of the present invention the ratchet wrench 50 includes: a handle 12, shaft 14, head 16, drive member 20, switch 22 and internal ratcheting mechanism 18. Similar to the first embodiment of the present invention the extension piece 40 may in addition to being employed as a driver extension for accessing a hard to reach fastener, the extension 40 may alternatively be used to increase the ratchet wrench torque leverage.

The ratchet wrench in the second embodiment has an addendum 55 protruding from the ratchet wrench handle 12. Adjacent the distal end of the tubular handle 13 as best seen in FIG. 5 is a generally square addendum 55. The square addendum 55 is complementary in size and shape to the square female receptacle 44 of the extension 40. The square addendum 55 has a spring-loaded detent ball (unnumbered) for assisting in securely coupling the extension 40 to the ratchet wrench 10.

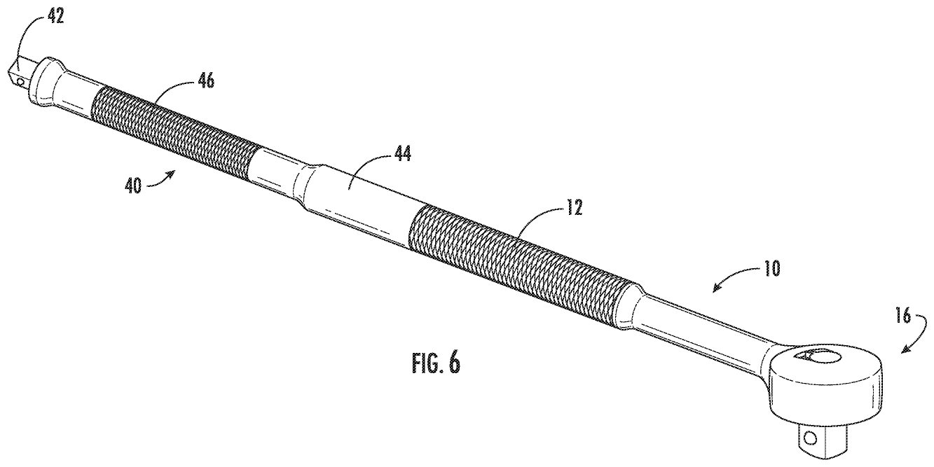

The extension 40 is coupled to the ratchet wrench 50 by first aligning the central axis of the extension with the longitudinal axis of the wrench; next rotating the extension so that the square male addendum is oriented to coincide with the position of the square female receptacle 44: and then finally fully inserting the male addendum 55 into the square female receptacle 44 of the extension 40. FIG. 6 illustrates the second embodiment of the invention wherein the extension 40 is attached to the end of the second embodiment ratchet wrench 50. As discussed above a selected socket is coupled to the drive member of the ratchet wrench in FIG. 6. To complete the assembly.

Upon coupling the extension 40 onto the ratchet wrench handle 50 a user may now grasp the extension 40 to rotate the ratchet wrench 50 and tighten or loosen a fastener. Whenever the ratchet wrench set is assembled together as shown in FIG. 4 greater torque can be more easily applied by the user to tighten or loosen a fastener as discussed above on account of the greater leverage achieved by the additional length of the wrench contributed by the extension 40.

Alternatively the ratchet wrenches 10, 50 male connectors 42 and/or drive members 20 and addendum (second embodiment only) may all have a hexagonal surfaces, so long as both the sockets female coupler hole 31 and the extension female receptacle 44 each have hexagonal surface configurations complimentary to the male connector and/or drive member surface configuration. Further the complimentary male and female coupling surfaces in the present invention may instead be pentagonal surfaces or other well-known coupling surface configurations.

The handgrip 46 on the extension included with both the first and second ratchet wrench sets of the present invention may alternatively be smooth and have no knurls, a workman would still be able to grasp the extension 40 less handgrips just not as well. In another embodiment the handgrip 46 may comprise of other well-known good gripping structure than knurls to assist a workman in gripping the extension 40. Further the diameter of the shaft 48 may be uniform from the inner end 49 of female receptacle portion to the inner end 43 of the male connector portion in a ratchet set of the present invention. Attaching any well-known ratchet wrench extension onto the end of the ratchet wrench of the first embodiment or second embodiment of the present invention would be beneficial in improving torque leverage so long as a workman could sufficiently grip the extension.

Other means for improving the grip on the extension than knurls may be employed including but not limited to a rubber or plastic sleeve.

In the present invention embodiments, the ratchet wrench square head drive member, extension male connectors and addendum (only second embodiment) may be ⅜-inch standard drive. In alternative embodiments, the ratchet head drives, extension male connectors and addendum (only second embodiment) may be ½, ¾ or one inch standard drives.

The first embodiment ratchet wrench set, and second embodiments ratchet wrench set of the present invention are comprised of tool steel. In another preferred embodiment of the present invention the first and second ratchet wrench sets may comprise of stainless steel.

It should also be understood that a fastener for purposes of this patent application will include any object or device which could be rotated or operated on by ratchet wrench 10. Fastener types may include are not limited to bolts and nuts. In addition, a socket in the ratchet set of the present may means for driving screws or include a spark plug deep socket. The screw driving means may include but are not limited to Phillips Head and other well-known drive head types.

These and other modification of the disclosure will be understood by those skilled in the art in view of the above description.

The invention claimed is:

1. A ratchet wrench set comprising:
a ratchet wrench having a head portion at one end and a handle portion at an opposite end,
at least one socket,
an extension having a male connector and a female portion, said female portion adapted to be coupled to said head portion and said at least one socket adapted to be coupled to said male connector, and
wherein said handle portion is adapted to be coupled with said extension for increasing the torque leverage of said ratchet wrench.

2. The ratchet wrench set according to claim 1, wherein said handle portion has a receptacle for receiving said extension male connector.

3. The ratchet wrench set according to claim 1, wherein said handle portion has a handle and male member section, said handle male member section is located at a distal end of said handle and adapted to couple with said extension female portion.

4. The ratchet wrench set according to claim 1, wherein said extension has a handgrip.

5. The ratchet wrench set according to claim 4, wherein said handgrip is substantially cylindrical.

6. The ratchet wrench set according to claim 5, wherein said ratchet wrench handle is substantially cylindrical, and said cylindrical handgrip has a diameter that is approximately equal to said cylindrical handle diameter.

7. The ratchet wrench set according to claim 6, wherein said extension handgrip is knurled.

8. The ratchet wrench set according to claim 7, wherein said ratchet wrench extension has a length of between 18 inches to 22 inches.

9. The ratchet wrench set according to claim 2, wherein said receptacle is substantially square.

10. The ratchet wrench set according to claim 3, wherein said male member section is substantially square.

11. A ratchet wrench comprising:
a ratchet wrench having a head portion at one end and a handle portion at an opposite end,
wherein said handle portion has a handle and said handle is adapted to be coupled with an elongated member.

12. The ratchet wrench according to claim 11, wherein said handle has a receptacle for coupling with said elongated member.

13. The ratchet wrench according to claim 11, wherein said handle has a male addendum section, said handle male addendum section is located at a distal end of said handle and adapted for coupling with said elongated member.

14. A ratchet wrench extension comprising:
a male connector and a female portion, said female portion connected to said male connector by a cylindrical shaft,
wherein said extension has a handgrip.

15. The ratchet wrench extension according to claim 14, wherein said handgrip is substantially cylindrical.

16. The ratchet wrench extension according to claim 15, wherein said ratchet wrench cylindrical handgrip has a diameter greater than said cylindrical shaft.

17. The ratchet wrench set according to claim 16, wherein both said male connector and female portion are substantially complimentary square shaped.
